(19) United States
(12) Patent Application Publication
(10) Pub. No.: US 2020/0408231 A1
(43) Pub. Date: Dec. 31, 2020

(54) CORNER CLAMP, A METHOD OF PRODUCING SUCH A CORNER CLAMP, AND A BOX STRUCTURE

(71) Applicant: Nefab Packaging Netherlands, Barneveld (NL)

(72) Inventors: David NOWAK, Hasselt (BE); Hans NELEN, Son en Breugel (NL)

(21) Appl. No.: 16/913,069

(22) Filed: Jun. 26, 2020

(30) Foreign Application Priority Data
Jun. 28, 2019 (EP) 19183280.7

(51) Int. Cl. F16B 5/06; B65D 6/34; B65D 5/44

(52) U.S. Cl. CPC F16B 5/0614; B65D 5/448; B65D 9/34

(57) ABSTRACT

A corner clamp (1) comprising: a first portion (2) having a first wall (3), a second wall (4) and an interconnecting portion (5) that interconnects the first wall (3) with the second wall (4), wherein the first wall (3), the second wall (4) and the interconnecting portion (5) together define a U-shaped cross-section, a second portion (6) having a first wall (7), a second wall (8) and interconnecting portion (9) that interconnects the first wall (7) with the second wall (8), wherein the first wall (7), the second wall (8) and the interconnecting portion (9) together define a U-shaped cross-section, an interconnection member (10) which interconnects the first portion (2) with the second portion (6). Along at least one of the first wall (3, 7) and second wall (4, 8) of the first portion (2) or the second portion (6) there is provided at least one barb (11) on an inner side of said wall (3, 4, 7, 8), said barb (11) having a tip (12) pointing in a direction towards the interconnecting portion (5, 9) that interconnects said first and second wall (3, 4, 7, 8).

### TECHNICAL FIELD

The present invention relates to a corner clamp for interconnecting a first wall element of a box structure to a second wall element of said box structure, said corner clamp comprising:
a first portion having a first wall, a second wall and an interconnecting portion that interconnects the first wall with the second wall, wherein the first wall, the second wall and the interconnecting portion together define a U-shaped cross-section,
a second portion having a first wall, a second wall and interconnecting portion that interconnects the first wall with the second wall, wherein the first wall, the second wall and the interconnecting portion together define a U-shaped cross-section,
an interconnection member which interconnects the first portion with the second portion,
wherein, in an operative position in which the corner clamp interconnects a first and a second wall element of a box structure, the first portion is configured to enclose a part of the first wall element between its first wall and its second wall, and the second portion is configured to enclose a part of the second wall element between its first wall and its second wall.

The present invention also relates to a box structure comprising wall elements that are interconnected by a corner clamp according to the invention, and to a method of producing a corner clamp according to the invention.

### BACKGROUND

Rapid assembly of box structures is essential in industrial packing of goods. It may also be of importance to prevent unintentional disassembly of a once assembled box structure or to prevent intentional disassembly that cannot be proved to have taken place afterwards.

It is an object of the present invention to present a corner clamp which is easy to attach to wall elements that are to be connected by and to be held by the corner clamp.

It is also an object of the present invention to present a corner clamp that will prevent non-detectable disassembly of a box structure in which wall elements are connected by and held by the corner clamp.

It is also an object of the invention to present a box structure comprising such a corner clamp, in which box structure wall elements of the box structure will interact with the corner clamp in such a way that the above-mentioned objects are achieved.

It is also an object of the invention to present a method of producing a corner clamp according the invention, which method is non-complicated and reliable.

### SUMMARY

The object of the invention is achieved by means of a corner clamp for interconnecting a first wall element of a box structure to a second wall element of said box structure, said corner clamp comprising:
a first portion having a first wall, a second wall and an interconnecting portion that interconnects the first wall with the second wall, wherein the first wall, the second wall and the interconnecting portion together define a U-shaped cross-section,
a second portion having a first wall, a second wall and interconnecting portion that interconnects the first wall with the second wall, wherein the first wall, the second wall and the interconnecting portion together define a U-shaped cross-section,
an interconnection member which interconnects the first portion with the second portion,
wherein, in an operative position in which the corner clamp interconnects a first and a second wall element of a box structure, the first portion is configured to enclose a part of the first wall element between its first wall and its second wall, and the second portion is configured to enclose a part of the second wall element between its first wall and its second wall, said corner clamp being characterised in that along at least one of the first wall and second wall of the first portion or the second portion there is provided at least one barb on an inner side of said wall, said barb having a tip pointing in a direction towards the interconnecting portion that interconnects said first and second wall. Needless to say, the barb tip protrudes from the most adjacent parts of the wall surrounding said barb tip.

Provided that the wall elements of a box structure to be held by the corner clamp are of a material soft enough to be penetrated by the barb, the at least one barb will enable a relative smooth insertion of a wall element into the corner clamp in a direction from a base portion of the barb towards the tip thereof, i.e. from the opening of the U-shaped cross-section of the first or second portion of the corner clamp towards the interconnecting portion thereof. If, after such insertion of a wall into the corner clamp, any one tries to disengage the corner clamp by an opposite motion of the inserted wall element, the tip of the barb will dig into the surface of the wall element and prevent such motion. If such motion forced upon the wall element anyhow, the barb will leave visual scratches on the wall element that will enable detection of such forced removal of the wall element from the corner clamp.

Preferably, the barb comprises a hard material, such as metal or a suitable polymer, which enables it to engage and dig into wall elements of a softer material such as wood, plywood, corrugated paper or polymer.

According to one embodiment, there is provided at least one barb on the first wall of the first portion and at least one barb on the second wall of the first portion, said barbs having a respective tip pointing towards the interconnecting portion of the first portion.

According to one embodiment, there is provided at least one barb on the first wall of the second portion and at least one barb on the second wall of the second portion, said barbs having a respective tip pointing towards the interconnecting portion of the second portion.

According to one embodiment, said at least one barb provided on any one of said first and second walls of any one of the first or second portions comprises a plurality of barbs arranged in parallel along a line which is parallel with a line along which the respective wall is connected its associated interconnecting portion.

According to one embodiment, said at least one barb is V-shaped, wherein the opposing tip-forming edges of the barb are formed by a portion cut out of said first or second wall, and the part of the wall which is remote from the interconnecting portion being bent outwards in relation the remaining part of the wall such the point of the respective barb protrudes inwards from the surface of said remaining part of said first or second wall. The term V-shape includes multiplications of a V-shape, such as W-shapes, while such shapes still comprises at least one V-shaped element (barb).

According to one embodiment, at least one of the first and second portions of the corner clamp has a first tongue that has been cut out of the interconnecting portion of said first or second portion, and which is pliable to a position in which it is parallel with and forms an extension of the second wall of said first or second portion. Preferably, both the first and the second portion is provided with such a first tongue. The first tongue is preferably used to connect a sheet or a pallet to the wall elements already connected by the corner clamp.

According to one embodiment, at least one of the first and second portions of corner clamp has a second tongue that has been cut out of the respective first wall and out of the interconnecting portion of said first or second portion such that it has it has an L-shaped cross-section, and which is pliable to a position in which a part thereof is parallel with and forms an extension of the second wall of said first or second portion and another part thereof is perpendicular to said second wall. Preferably, both the first and the second portion is provided with such a second tongue. The second tongue is preferably used to connect a sheet to the wall elements already connected by the corner clamp, whereby the L-shaped tongue partly overlaps such sheet (further wall element).

According to one embodiment, the first tongue is cut out of the part of the second tongue which is cut out of the interconnecting portion of said first or second portion.

The object of the invention is also achieved by means of a box structure, comprising a first wall element and a second wall element extending with an angle in relation the first wall element and being adjacent thereto, wherein the first and second wall elements have a respective first edge along which they are interconnected and a respective second edge that that forms an angle with the respective first edge, wherein the second edges are in planar alignment with each other, said box structure being characterised in that the first wall element is connected to the second wall element by a corner clamp according to the invention, wherein the first portion of the corner clamp encloses the second edge of first wall element and the second portion of the corner clamp encloses the second edge of the second wall element.

The material of the barb or barbs is sufficiently hard in relation to the material of the first and second wall elements to enable the barbs to dig into the surface of first and second wall elements upon displacement of the wall elements in a direction away from the interconnecting portions of the first and second portion towards the opening of the U-shaped cross-section of said first and second portions. Preferably, the thickness of the first and second wall elements corresponds to the distance between the first and second wall of the first portion and the distance between the first and second wall of the second portion. This enables both a stable holding of the wall elements and will enable the tip of the barb to dig into the surface of the wall elements upon motion thereof in said opposite direction.

The object of the invention is also achieved by a method of producing a corner clamp according to the invention, said method being characterised by the following steps,
providing a sheet configured to be plied to form said first portion, said second portion and said interconnection member by cutting a predetermined pattern out of a blanket,
cutting at least two slits in said sheet, said slits defining opposed sides of a V-shaped barb to be formed from the sheet,
plying said sheet along a line defining a base line of said V-shaped barb, such that a tip of the cut-out barb projects out of a plane of a part of the sheet adjacent to the cut-out barb tip, and
forming the U-shaped cross-section of said first and second portion by plying said sheet.

According to one embodiment, the method also comprises the step of plying the sheet along the interconnection member such that the first and second walls of the first portion have extension planes that present an angle to the extension planes of the first and second walls of the second portion. In common embodiments, said angle is perpendicular.

Further features and advantages will be presented in the following detailed description of an embodiment of the present invention.

### BRIEF DESCRIPTION OF THE DRAWING

FIG. 1 is a perspective view of a corner clamp according to the invention in a first state, the interconnection member not yet being plied,

FIG. 2 is a perspective view of the corner clamp in FIG. 1 from an opposite direction,

FIG. 3 is a an end view according to I-I in FIG. 1,

FIG. 4 is a perspective view of the corner clamp according to the invention in a second state, after plying of the interconnection member and ready for assembly,

FIG. 5 is a perspective view of the corner clamp in FIG. 4, from an opposite direction,

FIG. 6 is perspective view of a part of a box structure according to the invention, and

FIG. 7 is a perspective view corresponding to the one shown in FIG. 6, with an added further wall element to the box structure.

### DETAILED DESCRIPTION OF EMBODIMENTS

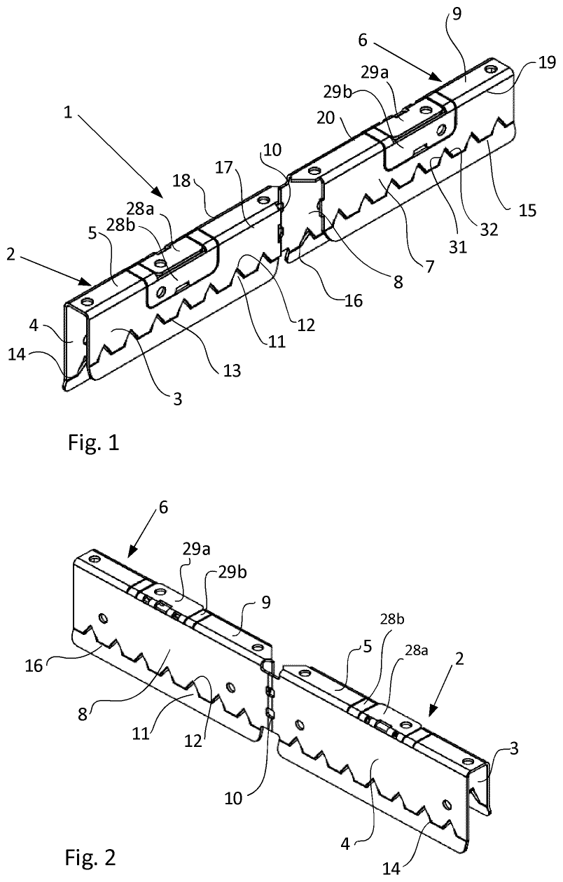

FIGS. 1 and 2 show a corner clamp 1 for interconnecting a first wall element of a box structure to a second wall element of the box structure. The corner clamp 1 comprises a first portion 2 having a first wall 3, a second wall 4 and an interconnecting portion 5 that interconnects the first wall 3 with the second wall 4. The first wall 3, the second wall 4 and the interconnecting portion 5 of the first portion 2 define a U-shaped cross-section. The corner clamp 1 further comprises a second portion 6 having a first wall 7, a second wall 8 and interconnecting portion 9 that interconnects the first wall 7 with the second wall 8, wherein the first wall 7, the second wall 8 and the interconnecting portion 9 of the second portion 6 together define a U-shaped cross-section.

The corner clamp 1 further comprises an interconnection member 10 which interconnects the first portion 2 with the second portion 3. FIGS. 1 and 2 show the interconnection member 10 in a not yet plied state. The interconnection member 10 comprises a sheet portion with holes therein for the purpose of facilitating the plying thereof.

Along the first wall 3 and second wall 4 of the first portion 2 and along the first wall 7 and the second wall 8 of the second portion 6 there is provided a plurality of barbs 11 on an inner side of the respective first and second walls 3, 4, 7, 8. Each of the barbs 11 has a tip 12 pointing in a direction towards the respective interconnecting portion 5, 9 that interconnects said first and second wall 3, 4, 7, 8 of the respective first and second portion 2, 6.

The barbs 11 of each respective wall 3, 4, 7, 8 are arranged in parallel along a line 13, 14, 15, 16 which is parallel with a line 17, 18, 19, 20 along which the respective associated wall 3, 4, 7, 8 is connected its associated interconnecting portion 6, 9. Said line 13, 14, 15, 16 along which the barbs 11 are arranged in parallel forms a base line of the barbs 11 from which the barbs 11 protrude in relation the parts of respective walls 3, 4, 7, 8 that is adjacent to the barbs 11, surround the bars 11 and define the main extension planes of the walls 3, 4, 7, 8. The main extension planes of the first wall 3 and the second wall 4 of the first portion 2 are parallel, and the main extension planes of the first wall 7 and the second wall 8 of the second portion 6 are parallel.

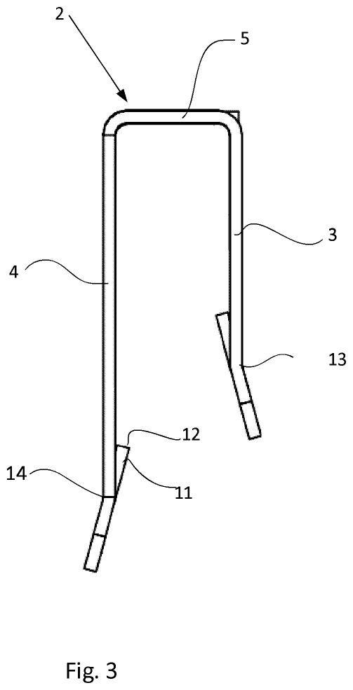

Each barb 11 is V-shaped, wherein the opposing tip-forming edges 31, 32 of the barb 11 are formed by a portion cut out of said first and second walls 3, 4, 7, 8. The part of the wall 3, 4, 7, 8 which is remote from the interconnecting portion 6, 9 is bent outwards in relation the remaining part of the wall 3, 4, 7, 8 along said base line 13, 14, 15, 16 such that the tip of the respective barb 11 protrudes inwards from the surface of said remaining part of said first or second wall 3, 4, 7, 8. The design is further shown by FIG. 3.

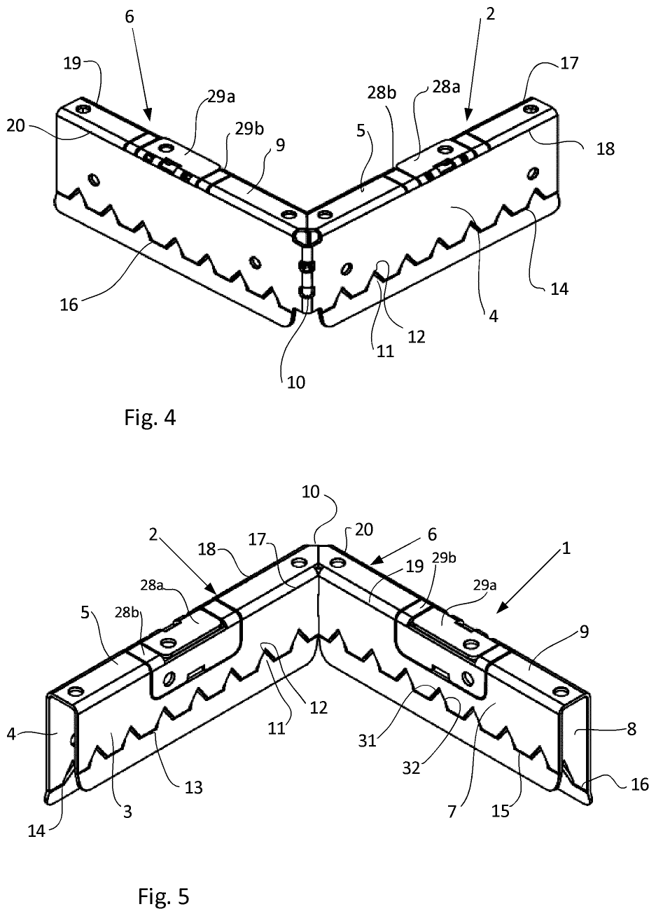

FIGS. 4 and 5 show the corner clamp 1 in a state ready for assembly of wall elements of a box structure. The interconnection member 10 is in a plied state in which the main extension planes of the first and second walls 3, 4 of the first portion 2 is generally perpendicular to the main extension planes of the first and second walls 7, 8 of the second portion 6. However, the angle is off course only dependent on the shape of the box structure. Thus other angles than 90° are conceivable.

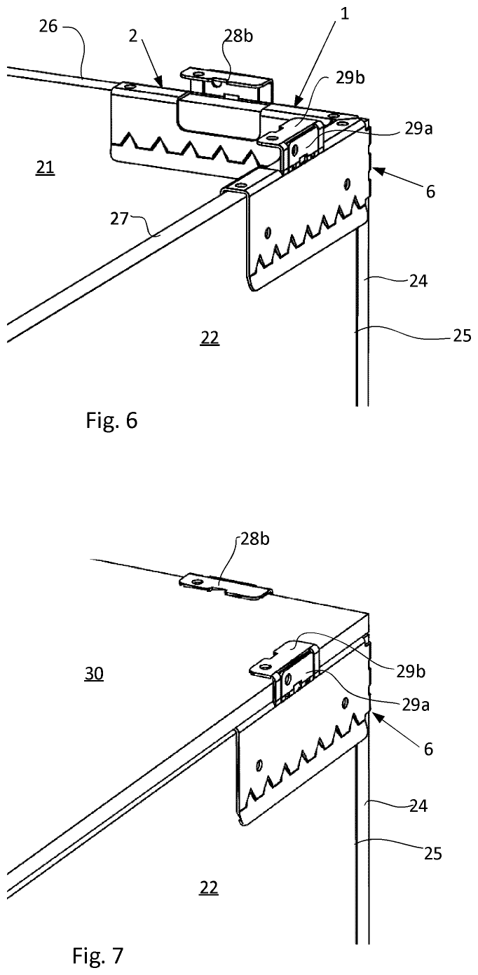

FIG. 6 shows the corner clamp in an operative position in which the corner clamp 1 interconnects a first and a second wall element 21, 22 of a box structure 23. The first portion 2 of the corner clamp 1 encloses a part of the first wall element 21 between its first wall 3 and its second wall 4 and the second portion 6 of the corner clamp 1 encloses a part of the second wall element 22 between its first wall 7 and its second wall 8.

The second wall element 22 extends with an angle in relation the first wall element 21 and is adjacent thereto, wherein the first and second wall elements 21, 22 have a respective first edge 24, 25 along which they are interconnected and a respective second edge 26, 27 that are perpendicular to the respective first edge, wherein the second edges 26, 27 are in planar alignment with each other. The first wall element 21 is connected to the second wall element by a corner clamp 1 as defined hereinabove, wherein the first portion 2 of the corner clamp encloses the second edge 26 of first wall element 21 and the second portion 6 of the corner clamp 1 encloses the second edge 27 of the second wall element 22.

With reference to FIGS. 1-5, each of the first and second portions 2, 6 of the corner clamp 1 has a first tongue 28a, 29a that has been cut out of the interconnecting portion 5, 8 of said first or second portion 2, 6, and which is pliable to a position in which it is parallel with and forms an extension of the second wall 8 of said first and second portion 2, 6.

Further, each of the first and second portions 2, 6 of corner clamp 1 has a second tongue 28b, 29b that has been cut out of the respective first wall 3, 7 and out of the interconnecting portion 5, 8 of said first and second portion 2, 6 such that it has it has an L-shaped cross-section, and which is pliable to a position in which a part thereof is parallel with and forms an extension of the second wall (8) of said first or second portion 2, 6 and another part thereof is perpendicular to said second wall 8.

The first tongue 28a, 29a is cut out of the part of the second tongue 28b, 29b which is cut out of the interconnecting portion 5,8 of said first or second portion 2, 6.

The first walls 3, 7 are configured to be attached to the inside of the wall elements 21, 22 of the box structure. A line 17, 19 along which the respective associated wall 3, 7 is connected its associated interconnecting portion 6, 9 forms a ply line along which the respective tongue 28a, 28b, 29a, 29b can be bent to an deflected position in which it is able of overlapping a further wall element or lid 30 arranged against the second edges 26, 27 of the first and second wall elements 21, 22. FIG. 6 shows the corner clamp 1 with its tongues 28a, 28b, 29a and 29b in their deflected positions ready for receipt of the further wall element 30. FIG. 7 shows the corner clamp 1 with its tongues 28a, 28b, 29a and 29b in their deflected positions ready while overlapping a further wall element 30 attached to the first and second wall elements 21, 22. If the corner clamp 1 is to be attached to a pallet, only the first tongues 28a, 29a are plied to their deflected position in which they are parallel with their associated second wall 8. The tongues 28a, 28b, 29a and 29b are preferably provided with screw holes through which screws or nails may be driven into any further element to which the clamp 1 is attached via any of the tongues 28a, 28b, 29a and 29b.

The corner clamp 1 is preferably produced by means of a method comprising the following steps,
providing a base sheet configured to be plied to form said first portion 2, said second portion 6 and said interconnection member 10 by cutting a predetermined pattern out of a blanket,
cutting pairs of slits defining opposed edges 31, 32 of each V-shaped barb 11 to be formed from the sheet,
plying said sheet along lines defining base lines 13, 14, 15, 16 of said V-shaped barbs 11, such that the tips 12 of the cut-out barbs 11 project out of a plane of a part of the sheet adjacent to the cut-out barb tip,
forming the U-shaped cross-section of said first and second portion 2, 6 by plying said sheet, thereby forming said first walls 3, 7, second walls 4, 8 and interconnecting portions 5, 9 of the respective first and second portion 2, 6 of the corner clamp 1, and plying the sheet along the interconnection member 10 such that the first and second walls 3, 4 of the first portion 2 have extension planes that are perpendicular to the extension planes of the first and second walls 7, 8 of the second portion 6.

In one embodiment, cutting may be include stamping.

The method may also comprise the step of cutting out the tongues 28a, 28b, 29a and 29b from the sheet and plying the latter along their ply lines defined hereinabove such that they are in the above-mentioned position ready for overlapping and being attached to the further wall element 30 or a pallet.

When assembling a box structure by means of one or more corner clamps 1, such corner clamps may, according to one embodiment, first be attached to said further wall element 30, followed by pushing them onto the second edges 26, 27 of the first and second wall elements 21, 22.

1. A corner clamp (1) for interconnecting a first wall element of a box structure to a second wall element of said box structure, said corner clamp (1) comprising:
a first portion (2) having a first wall (3), a second wall (4) and an interconnecting portion (5) that interconnects the first wall (3) with the second wall (4), wherein the first wall (3), the second wall (4) and the interconnecting portion (5) together define a U-shaped cross-section,
a second portion (6) having a first wall (7), a second wall (8) and interconnecting portion (9) that interconnects the first wall (7) with the second wall (8), wherein the first wall (7), the second wall (8) and the interconnecting portion (9) together define a U-shaped cross-section, and
an interconnection member (10) which interconnects the first portion (2) with the second portion (6),
wherein, in an operative position in which the corner clamp (1) interconnects a first and a second wall element (21, 22) of a box structure, the first portion (2) is configured to enclose a part of the first wall element (21) between its first wall (3) and its second wall (4), and the second portion (6) is configured to enclose a part of the second wall element (22) between its first wall (7) and its second wall (8), and
along at least one of the first wall (3, 7) and second wall (4, 8) of the first portion (2) or the second portion (6), there is provided at least one barb (11) on an inner side of said wall (3, 4, 7, 8), said barb (11) having a tip (12) pointing in a direction towards the interconnecting portion (5, 9) that interconnects said first and second wall (3, 4, 7, 8).

2. A corner clamp (1) according to claim 1, wherein there is provided at least one barb (11) on the first wall (3) of the first portion (2) and at least one barb (11) on the second wall (4) of the first portion (2), said barbs (11) having a respective tip (12) pointing towards the interconnecting portion (5) of the first portion (2).

3. A corner clamp (1) according to claim 1 or 2, wherein there is provided at least one barb (11) on the first wall (7) of the second portion (6) and at least one barb (11) on the second wall (8) of the second portion (6), said barbs (11) having a respective tip (12) pointing towards the interconnecting portion (9) of the second portion (6).

4. A corner clamp (1) according to claim 1, wherein said at least one barb (11) provided on any one of said first and second walls (3, 4, 7, 8) of any one of the first or second portions (2, 6) comprises a plurality of barbs (11) arranged in parallel along a line (13, 14, 15, 16) parallel with a line (17, 18, 19, 20) along which the respective wall (3, 4, 7, 8) is connected its associated interconnecting portion (5, 9).

5. A corner clamp (1) according to claim 1, wherein said at least one barb (11) is V-shaped, opposing tip-forming edges (31, 32) of the barb (11) are formed by a portion cut out of said first or second wall (3, 4, 7, 8), and the part of the wall which is remote from the interconnecting portion (5, 9) being bent outwards in relation the remaining part of the wall such the point of the respective barb (11) protrudes inwards from the surface of said remaining part of said first or second wall (3, 4, 7, 8).

6. A corner clamp (1) according to claim 1, wherein at least one of the first and second portions (2, 6) of the corner clamp (1) has a first tongue (28a, 29a) that has been cut out of the interconnecting portion (5, 8) of said first or second portion (2, 6), and which is pliable to a position in which it is parallel with and forms an extension of the second wall (8) of said first or second portion (2, 6).

7. A corner clamp according to claim 1, wherein at least one of the first and second portions (2, 6) of corner clamp (1) has a second tongue (28b, 29b) that has been cut out of the respective first wall (3, 7) and out of the interconnecting portion (5, 8) of said first or second portion (2, 6) such that it has it has an L-shaped cross-section, and which is pliable to a position in which a part thereof is parallel with and forms an extension of the second wall (8) of said first or second portion (2, 6) and another part thereof is perpendicular to said second wall (8).

8. A corner clamp according to claim 6, wherein
at least one of the first and second portions (2, 6) of corner clamp (1) has a second tongue (28b, 29b) that has been cut out of the respective first wall (3, 7) and out of the interconnecting portion (5, 8) of said first or second portion (2, 6) such that it has it has an L-shaped cross-section, and which is pliable to a position in which a part thereof is parallel with and forms an extension of the second wall (8) of said first or second portion (2, 6) and another part thereof is perpendicular to said second wall (8), and
the first tongue (28a, 29a) is cut out of the part of the second tongue (228b, 29b) which is cut out of the interconnecting portion (5,8) of said first or second portion (2, 6).

9. A box structure, comprising a first wall element (21) and a second wall element (22) extending with an angle in relation the first wall element (21) and being adjacent thereto, wherein
the first and second wall elements (21, 22) have a respective first edge (24, 25) along which they are interconnected and a respective second edge (26, 27) that that forms an angle with the respective first edge (24, 25),
the second edges (26, 27) are in planar alignment with each other,
the first wall element (21) is connected to the second wall element (22) by a corner clamp (1) according to claim 1, and
the first portion (2) of the corner clamp (1) encloses the second edge (26) of first wall element (21) and the second portion (6) of the corner clamp (1) encloses the second edge (27) of the second wall element (22).

10. A method of producing a corner clamp (1) according to claim 1, comprising the following steps,
providing a sheet configured to be plied to form said first portion (2), said second portion (6) and said interconnection member by cutting a predetermined pattern out of a blanket,
cutting at least two slits in said sheet, said slits defining opposed sides of a V-shaped barb (11) to be formed from the sheet,
plying said sheet along a line (13, 14, 15, 16) defining a base line of said V-shaped barb (11), such that a tip (12) of the cut-out barb (11) projects out of a plane of a part of the sheet adjacent to the cut-out barb tip (12), and
forming the U-shaped cross-section of said first and second portion (2, 6) by plying said sheet.

11. A method according to claim 10, additionally comprising the step of plying the sheet along the interconnection member (10) such that the first and second walls (3, 4) of the first portion (2) have extension planes that present an angle to the extension planes of the first and second walls (7, 8) of the second portion (6).

12. A corner clamp (1) according to claim 2, wherein there is provided at least one barb (11) on the first wall (7) of the second portion (6) and at least one barb (11) on the second wall (8) of the second portion (6), said barbs (11) having a respective tip (12) pointing towards the interconnecting portion (9) of the second portion (6).

13. A corner clamp (1) according to claim 12, wherein said at least one barb (11) provided on any one of said first and second walls (3, 4, 7, 8) of any one of the first or second portions (2, 6) comprises a plurality of barbs (11) arranged in parallel along a line (13, 14, 15, 16) parallel with a line (17, 18, 19, 20) along which the respective wall (3, 4, 7, 8) is connected its associated interconnecting portion (5, 9).

14. A corner clamp (1) according to claim 3, wherein said at least one barb (11) provided on any one of said first and second walls (3, 4, 7, 8) of any one of the first or second portions (2, 6) comprises a plurality of barbs (11) arranged in parallel along a line (13, 14, 15, 16) parallel with a line (17, 18, 19, 20) along which the respective wall (3, 4, 7, 8) is connected its associated interconnecting portion (5, 9).

15. A corner clamp (1) according to claim 2, wherein said at least one barb (11) provided on any one of said first and second walls (3, 4, 7, 8) of any one of the first or second portions (2, 6) comprises a plurality of barbs (11) arranged in parallel along a line (13, 14, 15, 16) parallel with a line (17, 18, 19, 20) along which the respective wall (3, 4, 7, 8) is connected its associated interconnecting portion (5, 9).

16. A corner clamp (1) according to claim 15, wherein said at least one barb (11) is V-shaped, opposing tip-forming edges (31, 32) of the barb (11) are formed by a portion cut out of said first or second wall (3, 4, 7, 8), and the part of the wall which is remote from the interconnecting portion (5, 9) being bent outwards in relation the remaining part of the wall such the point of the respective barb (11) protrudes inwards from the surface of said remaining part of said first or second wall (3, 4, 7, 8).

17. A corner clamp (1) according to claim 14, wherein said at least one barb (11) is V-shaped, opposing tip-forming edges (31, 32) of the barb (11) are formed by a portion cut out of said first or second wall (3, 4, 7, 8), and the part of the wall which is remote from the interconnecting portion (5, 9) being bent outwards in relation the remaining part of the wall such the point of the respective barb (11) protrudes inwards from the surface of said remaining part of said first or second wall (3, 4, 7, 8).

18. A corner clamp (1) according to claim 13, wherein said at least one barb (11) is V-shaped, opposing tip-forming edges (31, 32) of the barb (11) are formed by a portion cut out of said first or second wall (3, 4, 7, 8), and the part of the wall which is remote from the interconnecting portion (5, 9) being bent outwards in relation the remaining part of the wall such the point of the respective barb (11) protrudes inwards from the surface of said remaining part of said first or second wall (3, 4, 7, 8).

19. A corner clamp (1) according to claim 12, wherein said at least one barb (11) is V-shaped, opposing tip-forming edges (31, 32) of the barb (11) are formed by a portion cut out of said first or second wall (3, 4, 7, 8), and the part of the wall which is remote from the interconnecting portion (5, 9) being bent outwards in relation the remaining part of the wall such the point of the respective barb (11) protrudes inwards from the surface of said remaining part of said first or second wall (3, 4, 7, 8).

20. A corner clamp (1) according to claim 4, wherein said at least one barb (11) is V-shaped, opposing tip-forming edges (31, 32) of the barb (11) are formed by a portion cut out of said first or second wall (3, 4, 7, 8), and the part of the wall which is remote from the interconnecting portion (5, 9) being bent outwards in relation the remaining part of the wall such the point of the respective barb (11) protrudes inwards from the surface of said remaining part of said first or second wall (3, 4, 7, 8).
